(19) United States
(12) Patent Application Publication
(10) Pub. No.: US 2018/0038654 A1
(43) Pub. Date: Feb. 8, 2018

(54) SYSTEM FOR FAULT TOLERANT PASSAGE ARRANGEMENTS FOR HEAT EXCHANGER APPLICATIONS

(71) Applicant: GENERAL ELECTRIC COMPANY, SCHENECTADY, NY (US)

(72) Inventors: Michael Stephen Popp, Kings Park, NY (US); Jared Matthew Wolfe, West Chester, OH (US); Ramon Martinez, Fairfield, OH (US); Jeffrey Douglas Rambo, Mason, OH (US); Nicolas Kristopher Sabo, West Chester, OH (US); Curt Edward Hogan, West Chester, OH (US)

(21) Appl. No.: 15/231,207

(22) Filed: Aug. 8, 2016

(51) Int. Cl. F28D 7/00; F28F 1/02; F01D 25/26; F02C 7/14; F02C 7/18; F28D 7/16; F02C 3/107

(52) U.S. Cl. CPC F28D 7/0008; F28D 7/1684; F28F 1/02; F02C 3/107; F02C 7/14; F02C 7/18; F01D 25/26; F28D 2021/0026

(57) ABSTRACT

The heat exchanger assembly includes a heat exchanger body and a plurality of columns of fluid passages arranged in a first direction within the heat exchanger body. The plurality of columns of fluid passages includes at least one first fluid column of fluid passages and at least two second fluid columns of fluid passages. The first fluid column is interspersed between two second fluid columns. The first fluid column includes a plurality of first fluid passages configured to channel a first fluid through the heat exchanger body. The at least two second fluid columns includes a plurality of second fluid passages configured to channel a second fluid through the heat exchanger body. The plurality of first fluid passages is offset with respect to the plurality of second fluid passages.

### BACKGROUND

The field of the disclosure relates generally to gas turbine engines and, more particularly, to a system for heat exchangers for use in a gas turbine engine.

At least some known gas turbine engines include one or more heat exchangers configured to cool and heat fluids within the gas turbine engine. Some heat exchangers include air-oil heat exchangers, fuel-oil heat exchangers, and air-air heat exchangers. To prevent leakage from one fluid stream within a heat exchanger to another fluid stream within the same heat exchanger, a double wall or redundant wall construction may be used. Double wall or redundant wall constructions add weight to the gas turbine engine and reduce the fuel efficiency of the gas turbine engine.

### BRIEF DESCRIPTION

In one aspect, a heat exchanger assembly configured to transfer heat between a first fluid and a second fluid is provided. The heat exchanger assembly includes a heat exchanger body and a plurality of columns of fluid passages arranged in a first direction within the heat exchanger body. The plurality of columns of fluid passages includes at least one first fluid column of fluid passages and at least two second fluid columns of fluid passages. The first fluid column is interspersed between two second fluid columns. The first fluid column includes a plurality of first fluid passages configured to channel a first fluid through the heat exchanger body. The plurality of first fluid passages each includes an elliptical cross-section fluid passage. The at least two second fluid columns includes a plurality of second fluid passages configured to channel a second fluid through the heat exchanger body. The pluralities of second fluid passages each include an elliptical cross-section fluid passage. The plurality of first fluid passages is offset with respect to the plurality of second fluid passages.

In another aspect, a gas turbine engine is provided. The gas turbine engine includes a core engine including a high pressure compressor, a combustor, and a high pressure turbine in a serial flow arrangement. The gas turbine engine also includes a low pressure compressor and a low pressure turbine drivingly coupled to the low pressure compressor through a shaft and a power gear box. The gas turbine engine further includes a heat exchanger assembly coupled to the power gear box. The heat exchanger assembly includes a heat exchanger body and a plurality of columns of fluid passages arranged in a first direction within the heat exchanger body. The plurality of columns of fluid passages includes at least one first fluid column of fluid passages and at least two second fluid columns of fluid passages. The first fluid column is interspersed between two second fluid columns. The first fluid column includes a plurality of first fluid passages configured to channel a first fluid through the heat exchanger body. The plurality of first fluid passages each includes an elliptical cross-section fluid passage. The at least two second fluid columns includes a plurality of second fluid passages configured to channel a second fluid through the heat exchanger body. The pluralities of second fluid passages each include an elliptical cross-section fluid passage. The plurality of first fluid passages is offset with respect to the plurality of second fluid passages.

In yet another aspect, a gas turbine engine is provided. The gas turbine engine includes a core engine including a high pressure compressor, a combustor, and a high pressure turbine in a serial flow arrangement. The gas turbine engine also includes an inner casing circumscribing the core engine and an outer casing circumscribing the inner casing. The inner and outer casings define an undercowl space therebetween. The gas turbine engine also includes a heat exchanger assembly disposed within the undercowl space. The heat exchanger assembly includes a heat exchanger body and a plurality of columns of fluid passages arranged in a first direction within the heat exchanger body. The plurality of columns of fluid passages includes at least one first fluid column of fluid passages and at least two second fluid columns of fluid passages. The first fluid column is interspersed between two second fluid columns. The first fluid column includes a plurality of first fluid passages configured to channel a first fluid through the heat exchanger body. The plurality of first fluid passages each includes an elliptical cross-section fluid passage. The at least two second fluid columns includes a plurality of second fluid passages configured to channel a second fluid through the heat exchanger body. The pluralities of second fluid passages each include an elliptical cross-section fluid passage. The plurality of first fluid passages is offset with respect to the plurality of second fluid passages.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIGS. 1-9 show example embodiments of the method and apparatus described herein.

FIG. 1 is a perspective view of an aircraft.

FIG. 2 is a schematic cross-sectional view of a gas turbine engine in accordance with an exemplary embodiment of the present disclosure that may be used with the aircraft shown in FIG. 1.

FIG. 3 is a schematic diagram of a heat exchanger.

FIG. 4 is a force diagram depicting forces on elliptical fluid passages within the heat exchanger shown in FIG. 3.

FIG. 5 is a perspective view of the heat exchanger shown in FIG. 3 with elliptical fluid passages.

FIG. 6 is a force diagram depicting forces on circular fluid passages within the heat exchanger shown in FIG. 3.

FIG. 7 is a perspective view of the heat exchanger shown in FIG. 3 with circular fluid passages.

FIG. 8 is a force diagram depicting forces on racetrack fluid passages within the heat exchanger shown in FIG. 3.

FIG. 9 is a perspective view of the heat exchanger shown in FIG. 3 with racetrack fluid passages.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The following detailed description illustrates embodiments of the disclosure by way of example and not by way of limitation. It is contemplated that the disclosure has general application to a system for cooling fluids in an aircraft engine.

Embodiments of the heat exchanger assembly described herein exchange heat between separate fluids in a gas turbine engine assembly. The heat exchanger assembly includes a plurality of columns of fluid passages. Each column of fluid passages includes a plurality of fluid passages arranged vertically in the column and each passage within the column of fluid passages is configured to channel the same fluid. In various embodiments, each passage includes an oblong or elliptical shaped cross-section. The columns of fluid passages are arranged horizontally within the heat exchanger assembly in an alternating pattern. That is, a heating fluid is channeled in a first column of fluid passages and the two adjacent columns of fluid passages channel cooling fluids. The fluid passages within a column are offset with respect to the fluid passages within the two adjacent columns. The heat exchanger assembly is a monolithic construction formed by milling a single solid block or by additive manufacturing methods.

The heat exchanger assemblies described herein offer advantages over known methods of exchanging heat between fluids in a gas turbine engine. More specifically, arranging the passages in the columns in an offset pattern minimizes the stress field between dissimilar fluids. Additionally, the elliptical shape of the passages combined with the arrangement of the fluid passages also minimizes the stress field between dissimilar fluids. The arrangement of the fluid passages ensures that, if a passage were to leak, the passage would leak into a passage which channels the same fluid rather than a passage which channels a different fluid, ensuring that a failure in one passage does not cause the entire heat exchanger to fail. Finally, the shape and arrangement of fluid passages improves the reliability of the heat exchanger assembly, eliminating the need for double wall or redundant wall construction, reducing the weight and cost of the gas turbine engine.

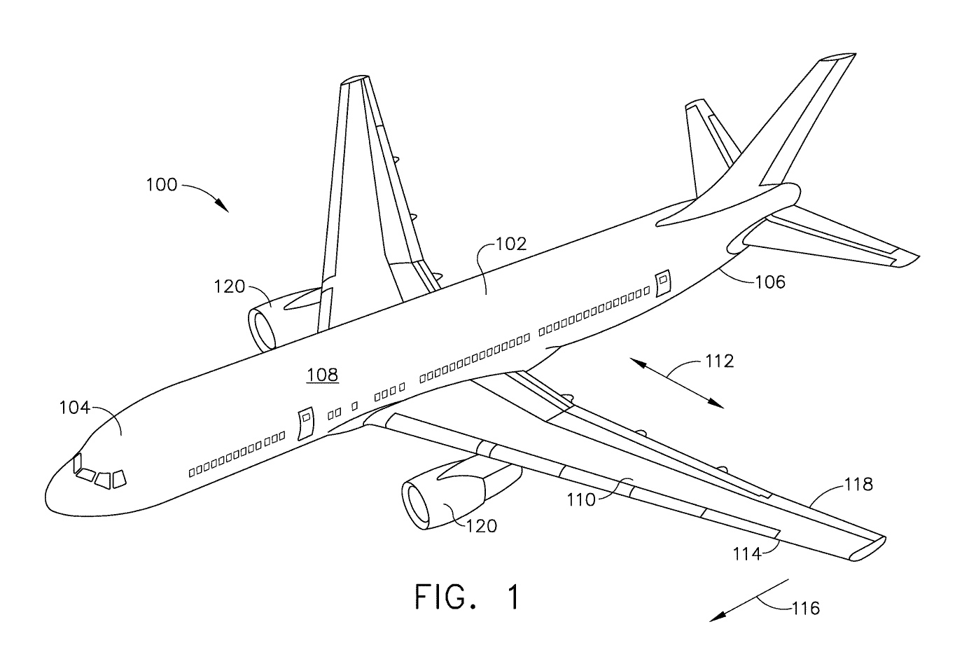

FIG. 1 is a perspective view of an aircraft 100. In the example embodiment, aircraft 100 includes a fuselage 102 that includes a nose 104, a tail 106, and a hollow, elongate body 108 extending therebetween. Aircraft 100 also includes a wing 110 extending away from fuselage 102 in a lateral direction 112. Wing 110 includes a forward leading edge 114 in a direction 116 of motion of aircraft 100 during normal flight and an aft trailing edge 118 on an opposing edge of wing 110. Aircraft 100 further includes at least one engine 120 configured to drive a bladed rotatable member or fan to generate thrust. Engine 120 is coupled to at least one of wing 110 and fuselage 102, for example, in a pusher configuration (not shown) proximate tail 106.

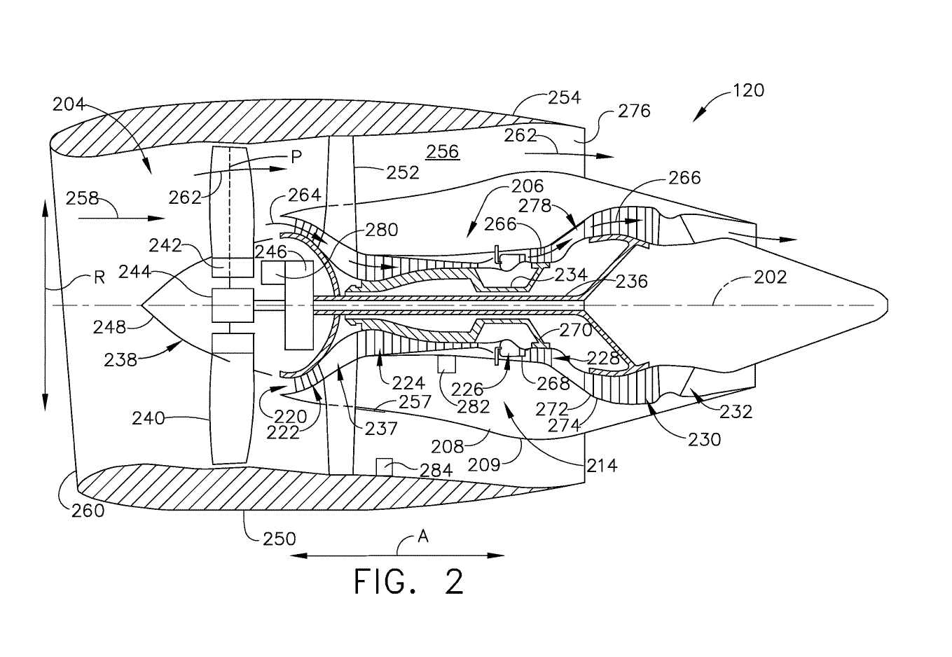

FIG. 2 is a schematic cross-sectional view of gas turbine engine 120 in accordance with an exemplary embodiment of the present disclosure. In the example embodiment, gas turbine engine 120 is embodied in a high bypass turbofan jet engine. As shown in FIG. 2, turbofan engine 120 defines an axial direction A (extending parallel to a longitudinal axis 202 provided for reference) and a radial direction R. In general, turbofan 120 includes a fan assembly 204 and a core turbine engine 206 disposed downstream from fan assembly 204.

In the example embodiment, core turbine engine 206 includes an approximately tubular outer casing 208 that defines an annular inlet 220 and a tubular inner casing 210 circumscribed by outer casing 208. Outer casing 208 and inner casing 210 encase, in serial flow relationship, a compressor section including a booster or low pressure (LP) compressor 222 and a high pressure (HP) compressor 224; a combustion section 226; a turbine section including a high pressure (HP) turbine 228 and a low pressure (LP) turbine 230; and a jet exhaust nozzle section 232. Outer casing 208 also includes an outer radial surface 209. A high pressure (HP) shaft or spool 234 drivingly connects HP turbine 228 to HP compressor 224. A low pressure (LP) shaft or spool 236 drivingly connects LP turbine 230 to LP compressor 222. The compressor section, combustion section 226, turbine section, and nozzle section 232 together define a core air flowpath 237. An undercowl space 214 is defined by the volume between inner casing 210 and outer casing 208.

In the example embodiment, fan assembly 204 includes a variable pitch fan 238 having a plurality of fan blades 240 coupled to a disk 242 in a spaced apart relationship. Although fan assembly 204 is described as including a variable pitch fan 238, fan assembly 204 could include a conventional fixed pitch fan. Fan blades 240 extend radially outwardly from disk 242. Each fan blade 240 is rotatable relative to disk 242 about a pitch axis P by virtue of fan blades 240 being operatively coupled to a suitable pitch change mechanism (PCM) 244 configured to vary the pitch of fan blades 240. In other embodiments, PCM 244 is configured to collectively vary the pitch of fan blades 240 in unison. Fan blades 240, disk 242, PCM 244, and LP compressor 222 are together rotatable about longitudinal axis 202 by LP shaft 236 across a power gear box 246.

Disk 242 is covered by rotatable front hub 248 aerodynamically contoured to promote an airflow through the plurality of fan blades 240. Additionally, fan assembly 204 includes an annular fan casing or outer nacelle 250 that circumferentially surrounds fan 238 and/or at least a portion of core turbine engine 206. In the example embodiment, nacelle 250 is configured to be supported relative to core turbine engine 206 by a plurality of circumferentially-spaced outlet guide vanes 252. Moreover, a downstream section 254 of nacelle 250 may extend over an outer portion of core turbine engine 206 so as to define a bypass airflow passage 256 therebetween.

During operation of turbofan engine 120, a volume of air 258 enters turbofan 120 through an associated inlet 260 of nacelle 250 and/or fan assembly 204. As volume of air 258 passes across fan blades 240, a first portion 262 of volume of air 258 is directed or routed into bypass airflow passage 256 and a second portion 264 of volume of air 258 is directed or routed into core air flowpath 237, or more specifically into LP compressor 222. A ratio between first portion 262 and second portion 264 is commonly referred to as a bypass ratio. The pressure of second portion 264 is then increased as it is routed through HP compressor 224 and into combustion section 226, where it is mixed with fuel and burned to provide combustion gases 266.

Combustion gases 266 are routed through HP turbine 228 where a portion of thermal and/or kinetic energy from combustion gases 266 is extracted via sequential stages of HP turbine stator vanes 268 that are coupled to outer casing 208 and HP turbine rotor blades 270 that are coupled to HP shaft or spool 234, thus causing HP shaft or spool 234 to rotate, which then drives a rotation of HP compressor 224. Combustion gases 266 are then routed through LP turbine 230 where a second portion of thermal and kinetic energy is extracted from combustion gases 266 via sequential stages of LP turbine stator vanes 272 that are coupled to outer casing 208 and LP turbine rotor blades 274 that are coupled to LP shaft or spool 236, which drives a rotation of LP shaft or spool 236, LP compressor 222, and rotation of fan 238 across power gear box 246.

Combustion gases 266 are subsequently routed through jet exhaust nozzle section 232 of core turbine engine 206 to provide propulsive thrust. Simultaneously, the pressure of first portion 262 is substantially increased as first portion 262 is routed through bypass airflow passage 256 before it is exhausted from a fan nozzle exhaust section 276 of turbofan 120, also providing propulsive thrust. HP turbine 228, LP turbine 230, and jet exhaust nozzle section 232 at least partially define a hot gas path 278 for routing combustion gases 266 through core turbine engine 206.

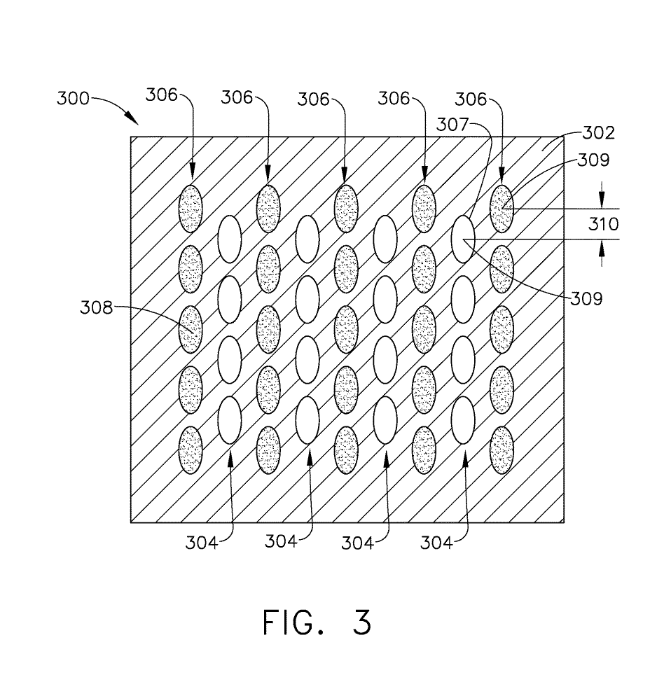

Exemplary embodiments of heat exchanger 300 (shown in FIG. 3) may be located in various locations within gas turbine engine 120. A heat exchanger 280 is coupled to power gear box 246 and exchanges heat between a lubricant stream (oil) from core turbine engine 206 and fuel. Heat exchanger 280 may also exchange heat between two streams of oil. In another embodiment, heat exchanger 280 may be formed integral to power gear box 246 rather than being a separate component coupled to power gear box 246. A heat exchanger 282 is disposed within undercowl space 214 and exchanges heat between two streams of air, for example, air from undercowl space 214 and bleed air from LP compressor 222 and HP compressor 224. Another air-air heat exchanger 284 is coupled to nacelle 250 and exchanges heat between two streams of air. Heat exchangers 280, 282, and 284 may be located in any location within gas turbine engine 120 which enables heat exchangers 280, 282, and 284 to operate as described herein. Other applications for heat exchangers 280, 282, and 284 include exchanging heat between a stream of fuel and a stream of air, a stream of lubricant (oil) and a stream of air, and a stream of refrigerant and a stream of air. Heat exchangers 280, 282, and 284 may be formed integral to pumps, controllers, valves, or any other components of gas turbine engine 120.

Exemplary turbofan engine 120 depicted in FIG. 2 is by way of example only, and in other embodiments, turbofan engine 120 may have any other suitable configuration. It should also be appreciated, that in still other embodiments, aspects of the present disclosure may be incorporated into any other suitable gas turbine engine. For example, in other embodiments, aspects of the present disclosure may be incorporated into, e.g., a turboprop engine.

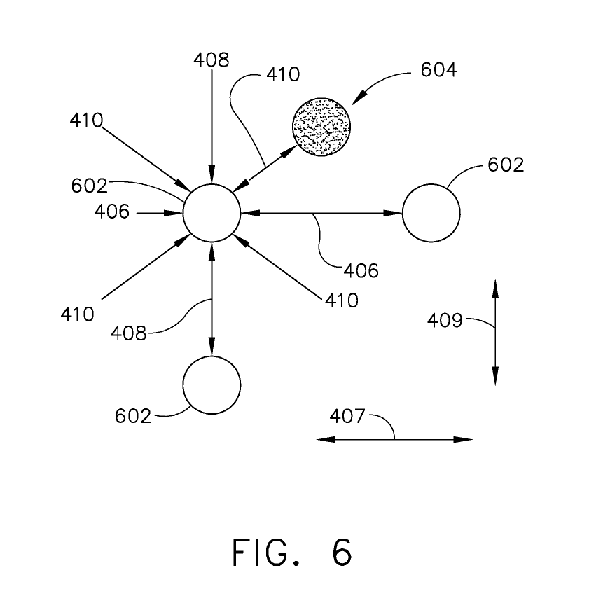

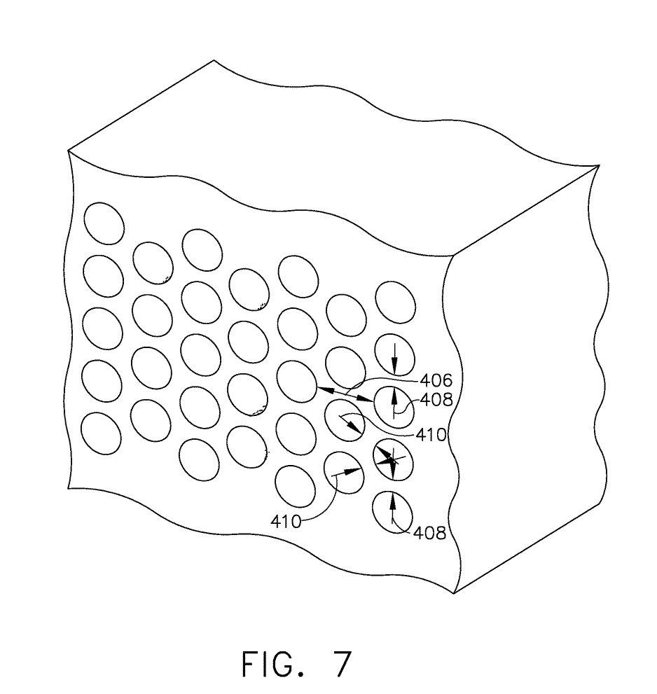

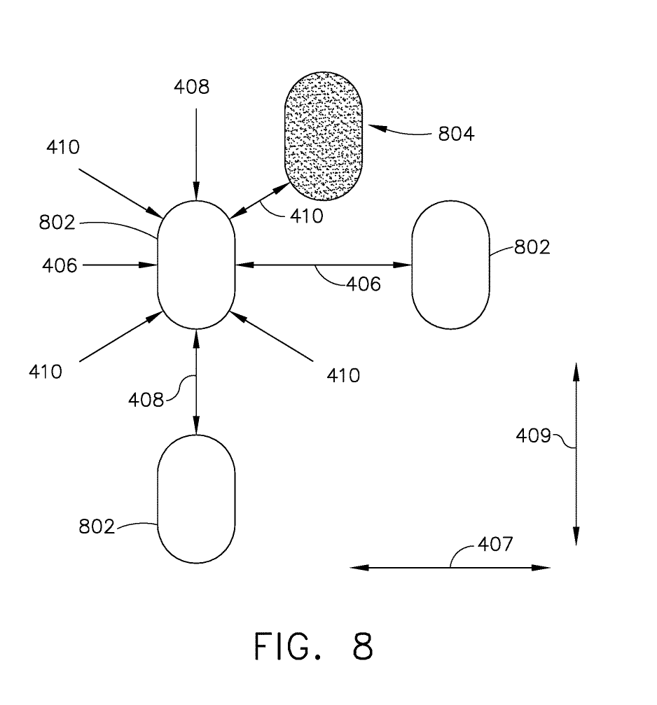

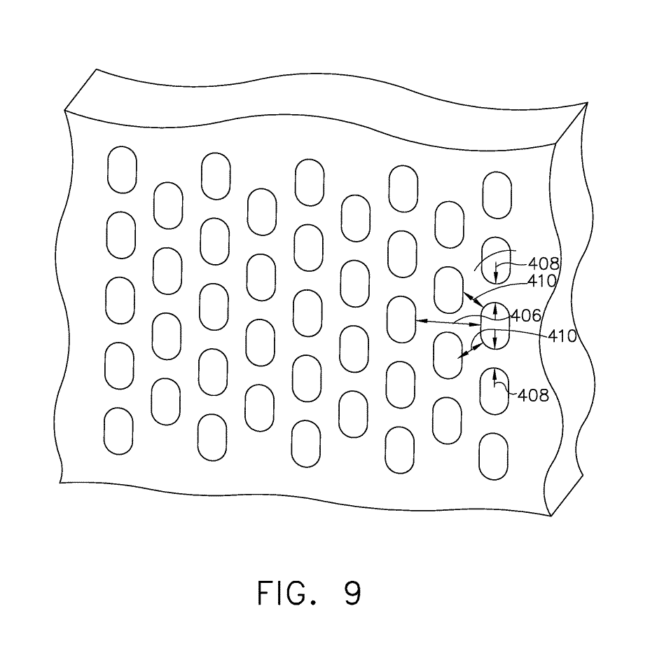

FIG. 3 is a cross-section of a heat exchanger 300. Heat exchanger 300 includes a heat exchanger body 302. In the exemplary embodiment, heat exchanger body 302 is a matrix style heat exchanger of unitary construction manufactured by printing a single block by additive manufacturing methods or by milling a single block of material. Heat exchanger body 302 includes a plurality of first columns 304 and a plurality of second columns 306 interdigitated with plurality of first columns 304. Each column 304 of plurality of first columns 304 includes a plurality of first flow passages 307 that extend into and out of the page as shown in FIG. 3. Each column 306 of plurality of second columns 306 includes a plurality of second flow passages 308 that also extend into and out of the page parallel with respect to each other of the plurality of first flow passages 307 and plurality of second flow passages 308. In one embodiment, shown in FIGS. 3-5, flow passages 307 and 308 include an elliptical or oblong cross-section having a centroid 309. In another embodiment, shown in FIGS. 6-7, flow passages 307 and 308 include a circular cross-section having a centroid 309. In yet another embodiment, shown in FIGS. 8-9, flow passages 307 and 308 include a racetrack cross-section having a centroid 309. First flow passages 307 are offset by a predetermined distance or pitch 310 (see FIG. 3) with respect to second flow passages 308.

FIGS. 3-9 show flow passages 307 and 308 with uniform cross-sectional areas. However, flow passages 307 and 308 may include varying cross-sectional areas or may include different cross-sections. For example, first columns 304 may include first flow passages 307 with circular cross-sections and second columns 306 may include second flow passages 308 with elliptical cross-sections. Additionally, the cross-sectional area of each first flow passage 307 of the plurality of first flow passages 307 may be distinct from the cross-sectional areas of the other first flow passages 307 within the plurality of first flow passages 307. The cross-section and cross-sectional areas of first and second flow passages 307 and 308 may be varied to achieve a required heat transfer rate or a required pressure drop through heat exchanger 300.

During operation, heat exchanger 300 is configured to transfer heat between a first fluid flowing in first flow passages 307 and a second fluid in second flow passages 308. First fluid and second fluid could include air, fuel, and oil. First passages 304 and second passages 306 may be configured in a counter-current flow arrangement or a parallel flow arrangement.

In the example embodiment, heat exchanger 300 is formed unitarily of a sintered metal material, using for example, an additive manufacturing process. In one embodiment, heat exchanger 300 is formed by an additive manufacturing process. The sintered metal material comprises a superalloy material, such as, but not limited to cobalt chrome, aluminum alloys, titanium alloys, and austenite nickel-chromium-based superalloys, and the like. As used herein, “additive manufacturing” refers to any process which results in a three-dimensional object and includes a step of sequentially forming the shape of the object one layer at a time. Additive manufacturing processes include, for example, three dimensional printing, laser-net-shape manufacturing, direct metal laser sintering (DMLS), direct metal laser melting (DMLM), selective laser sintering (SLS), plasma transferred arc, freeform fabrication, and the like. One exemplary type of additive manufacturing process uses a laser beam to sinter or melt a powder material. Additive manufacturing processes can employ powder materials or wire as a raw material. Moreover, additive manufacturing processes can generally relate to a rapid way to manufacture an object (article, component, part, product, etc.) where a plurality of thin unit layers are sequentially formed to produce the object. For example, layers of a powder material may be provided (e.g., laid down) and irradiated with an energy beam (e.g., laser beam) so that the particles of the powder material within each layer are sequentially sintered (fused) or melted to solidify the layer.

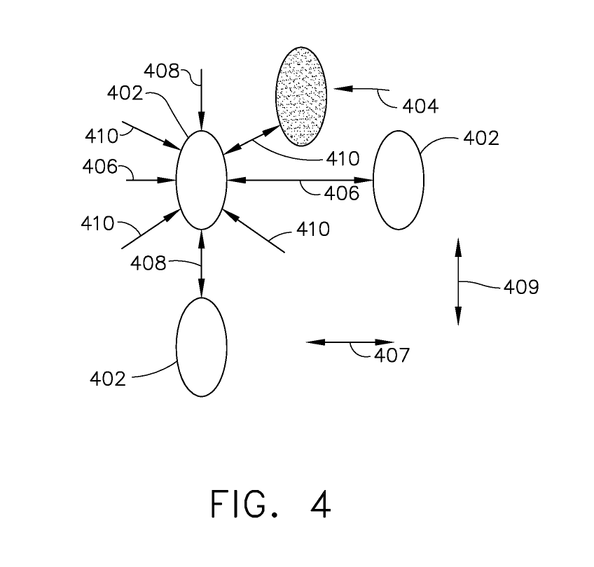

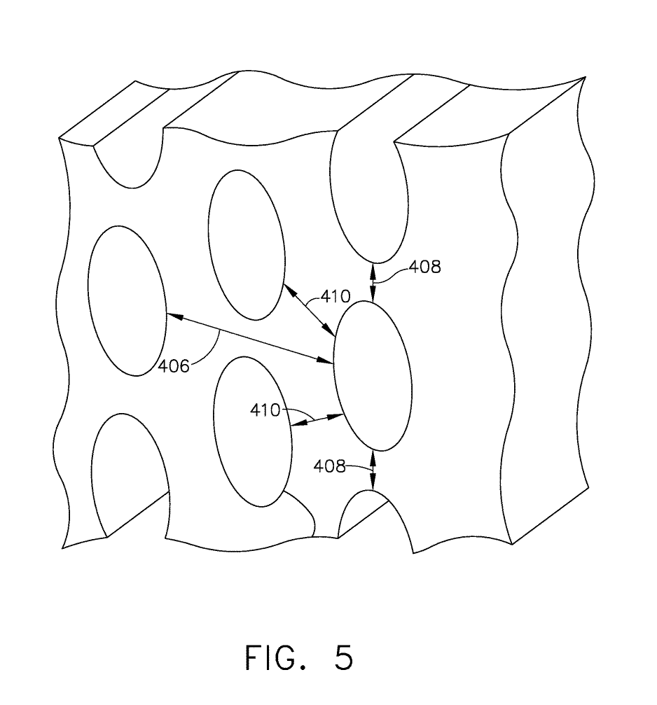

FIG. 4 is force diagram depicting forces acting on a fluid passage 402 with elliptical cross-sections, such as first flow passages 307 or second flow passages 308 (both shown in FIG. 3). FIG. 5 is a perspective view of heat exchanger 300 with fluid passage 402 with elliptical cross-sections. FIG. 6 is force diagram depicting forces acting on a fluid passage 602 with circular cross-sections. FIG. 7 is a perspective view of heat exchanger 300 with fluid passage 602 with circular cross-sections. FIG. 8 is force diagram depicting forces acting on a fluid passage 802 with racetrack cross-sections. FIG. 9 is a perspective view of heat exchanger 300 with fluid passage 802 with racetrack cross-sections. Fluid passages 402, 602, and 802 are fluid passages within first flow passages 307 and fluid passages 404, 604, and 804 are fluid passages within second flow passages 308. The forces acting on fluid passages 402, 602, and 802 are similar to each other. Fluid passages 402, 602, and 802 receive two horizontal forces 406 on either side of fluid passages 402, 602, and 802, two vertical forces 408 on top and on bottom of fluid passages 402, 602, and 802, and four diagonal forces 410 during operation of heat exchanger 300. Horizontal forces 406 act in a horizontal direction 407 and vertical forces act in a vertical direction 409. Horizontal forces 406 include compressive forces and vertical forces 408 include tensile forces. Horizontal forces 406, vertical forces 408, and diagonal forces 410 are created primarily by differential thermal expansion of first flow passages 307 relative to second flow passages 308 or by mechanical (pressure) loading of first flow passages 307 and second flow passages 308.

Diagonal forces 410 result in zero or near zero stress between fluid passages which channel dissimilar fluids. The highest stress due to forces between fluid passages originates from horizontal forces 406 and vertical forces 408. Horizontal forces 406 and vertical forces 408 result in stresses between fluid passages which channel the same fluids. Thus, the most likely failure mode for heat exchanger 300 is between fluid passages with similar fluids, which would not cause heat exchanger 300 to fail in operation because the flow in each passage is flowing in parallel already.

The offset arrangement described above orients fluid passages 308 such that horizontal forces 406 and vertical forces 408 act between fluid passages with like fluids. That is, if a failure were to occur due to either horizontal forces 406 or vertical forces 408, the fluid within fluid passage 402 would leak into a fluid passage channeling the same fluid as fluid passage 402. The only forces acting between fluid passages which channel dissimilar forces are diagonal forces 410. Thus, heat exchanger 300 is configured to fail, if at all, between two fluid passages with similar fluids that are always in the same fluid circuit. A failure between two fluid passages with dissimilar fluids is unlikely because diagonal forces 410 are significantly lower than horizontal forces 406 and vertical forces 408.

The above-described heat exchange assembly provides an efficient method for exchanging heat between fluids in a gas turbine engine. Specifically, arranging the passages in an offset pattern minimizes the stress field between passages carrying dissimilar fluids. More specifically, the shape of the passages combined with the arrangement of the fluid passages, minimizes the stress field between passages carrying dissimilar fluids. Additionally, the arrangement of the fluid passages ensures that, if a passage were to leak, the passage would leak into a passage which channels the same fluid rather than a passage which channels a different fluid, ensuring that a failure in one passage does not cause the entire heat exchanger to fail. Finally, the shape and arrangement of fluid passages improves the reliability of the heat exchanger assembly, eliminating the need for double wall or redundant wall construction, reducing the weight and cost of the gas turbine engine.

Exemplary embodiments of the heat exchanger assembly are described above in detail. The heat exchanger assembly, and methods of operating such systems and devices are not limited to the specific embodiments described herein, but rather, components of systems and/or steps of the methods may be utilized independently and separately from other components and/or steps described herein. For example, the methods may also be used in combination with other systems requiring heat exchange between fluids, and are not limited to practice with only the systems and methods as described herein. Rather, the exemplary embodiment can be implemented and utilized in connection with many other machinery applications that are currently configured to receive and accept heat exchanger assemblies.

Example methods and apparatus for exchanging heat between fluids are described above in detail. The apparatus illustrated is not limited to the specific embodiments described herein, but rather, components of each may be utilized independently and separately from other components described herein. Each system component can also be used in combination with other system components.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A heat exchanger assembly configured to transfer heat between a first fluid and a second fluid, said heat exchanger assembly comprising:
a heat exchanger body; and
a plurality of columns of fluid passages arranged in a first direction within said heat exchanger body, said plurality of columns of fluid passages comprising at least one first fluid column of fluid passages and at least two second fluid columns of fluid passages, said first fluid column interspersed between two second fluid columns;
wherein said at least one first fluid column comprises a plurality of first fluid passages configured to channel a first fluid through said heat exchanger body; and
wherein said at least two second fluid columns comprises a plurality of second fluid passages configured to channel a second fluid through said heat exchanger body, said plurality of first fluid passages offset with respect to said plurality of second fluid passages.

2. The heat exchanger assembly of claim 1, wherein said plurality of first fluid passages and said plurality of second fluid passages each comprising an elliptical cross-section fluid passage.

3. The heat exchanger assembly of claim 1, wherein said plurality of first fluid passages and said plurality of second fluid passages each comprising a circular cross-section fluid passage.

4. The heat exchanger assembly of claim 1, wherein said plurality of first fluid passages and said plurality of second fluid passages each comprising a racetrack cross-section fluid passage.

5. The heat exchanger assembly of claim 1, wherein said heat exchanger body is of unitary construction.

6. The heat exchanger assembly of claim 5, wherein a first sum of force vectors acting between a first fluid passage of said plurality of first fluid passages and a second fluid passage of said plurality of second fluid passages is equals approximately zero.

7. The heat exchanger assembly of claim 6, wherein a second sum of force vectors acting between said first fluid passage of said plurality of first fluid passages and a third fluid passage of said plurality of first fluid passages is greater than said first sum of force vectors, said third fluid passage is adjacent said first fluid passage.

8. The heat exchanger assembly of claim 1, wherein said plurality of first fluid passages are configured to channel a stream of fuel and said plurality of second fluid passages are configured to channel a stream of oil.

9. The heat exchanger assembly of claim 1, wherein said plurality of first fluid passages are configured to channel a stream of air and said plurality of second fluid passages are configured to channel a stream of oil.

10. The heat exchanger assembly of claim 1, wherein said plurality of first fluid passages are configured to channel a stream of fuel and said plurality of second fluid passages are configured to channel a stream of air.

11. The heat exchanger assembly of claim 1, wherein said plurality of first fluid passages are configured to channel a first stream of oil and said plurality of second fluid passages are configured to channel a second stream of oil.

12. The heat exchanger assembly of claim 1, wherein said plurality of first fluid passages are configured to channel a stream of refrigerant and said plurality of second fluid passages are configured to channel a stream of air.

13. A gas turbine engine comprising:
a core engine comprising a high pressure compressor, a combustor, and a high pressure turbine in a serial flow arrangement;
a low pressure compressor;
a low pressure turbine drivingly coupled to said low pressure compressor through a shaft and a power gear box;
a heat exchanger assembly coupled to said power gear box, said heat exchanger assembly comprising:
a heat exchanger body; and
a plurality of columns of fluid passages arranged in a first direction within said heat exchanger body, said plurality of columns of fluid passages comprising at least one first fluid column of fluid passages and at least two second fluid columns of fluid passages, said first fluid column interspersed between two second fluid columns;
wherein said at least one first fluid column comprises a plurality of first fluid passages configured to channel a first fluid through said heat exchanger body; and
wherein said at least two second fluid columns comprises a plurality of second fluid passages configured to channel a second fluid through said heat exchanger body, said plurality of first fluid passages offset with respect to said plurality of second fluid passages.

14. The gas turbine engine of claim 13, wherein said heat exchanger assembly coupled in flow communication with said power gear box, said plurality of first fluid passages are configured to channel a stream of fuel and said plurality of second fluid passages are configured to channel a stream of oil from said power gear box.

15. The gas turbine engine of claim 13, wherein said heat exchanger assembly coupled in flow communication with said power gear box, said plurality of first fluid passages are configured to channel a stream of first stream of oil from said core engine and said plurality of second fluid passages are configured to channel a second stream of oil from said power gear box.

16. The gas turbine engine of claim 13, wherein said heat exchanger assembly coupled in flow communication with said power gear box, said plurality of first fluid passages are configured to channel a stream of air and said plurality of second fluid passages are configured to channel a stream of oil from said power gear box.

17. The gas turbine engine of claim 13, wherein a first sum of force vectors acting between a first fluid passage of said plurality of first fluid passages and a second fluid passage of said plurality of second fluid passages is equals approximately zero.

18. The gas turbine engine of claim 17, wherein a second sum of force vectors acting between said first fluid passage of said plurality of first fluid passages and a third fluid passage of said plurality of first fluid passages is greater than said first sum of force vectors, said third fluid passage is adjacent said first fluid passage.

19. A gas turbine engine assembly comprising:
a core engine comprising a high pressure compressor, a combustor, and a high pressure turbine in a serial flow arrangement;
an inner casing circumscribing said core engine;
an outer casing circumscribing said inner casing, said outer casing and said inner casing defining an undercowl space therebetween;
a heat exchanger assembly disposed within said undercowl space, said heat exchanger assembly comprising:
a heat exchanger body; and
a plurality of columns of fluid passages arranged in a first direction within said heat exchanger body, said plurality of columns of fluid passages comprising at least one first fluid column of fluid passages and at least two second fluid columns of fluid passages, said first fluid column interspersed between two second fluid columns;
wherein said at least one first fluid column comprises a plurality of first fluid passages configured to channel a first fluid through said heat exchanger body; and
wherein said at least two second fluid columns comprises a plurality of second fluid passages configured to channel a second fluid through said heat exchanger body, said plurality of first fluid passages offset with respect to said plurality of second fluid passages.

20. The gas turbine engine assembly of claim 19, wherein said plurality of first fluid passages are configured to channel a first stream of air from said undercowl space and said plurality of second fluid passages are configured to channel a second stream of air from said high pressure compressor.
